(19) United States
(12) Patent Application Publication
(10) Pub. No.: US 2025/0004342 A1
(43) Pub. Date: Jan. 2, 2025

(54) Waveguide Display with Sealed Tint Layer

(71) Applicant: Apple Inc., Cupertino, CA (US)

(72) Inventors: Zachary M. Beiley, Oakland, CA (US); Sean E. Doris, San Francisco, CA (US); Tuncay Ozel, San Jose, CA (US); Alexander D. Schlaupitz, Longmont, CO (US); Xiaonan Wen, San Jose, CA (US)

(21) Appl. No.: 18/743,709

(22) Filed: Jun. 14, 2024

Related U.S. Application Data
(60) Provisional application No. 63/511,585, filed on Jun. 30, 2023.

(51) Int. Cl. G02F 1/157; G02B 27/01; G02F 1/1503; G02F 1/1514; G02F 1/161

(52) U.S. Cl. CPC G02F 1/157; G02B 27/0172; G02F 1/1503; G02F 1/1514; G02F 1/161; G02B 2027/0118

(57) ABSTRACT

An electronic device may include a display with a waveguide that directs image light to an eye box using an output coupler. The display may include an electrically adjustable tint layer overlapping the output coupler. The tint layer may serve to maximize contrast of images in the image light. The tint layer may include a peripheral edge seal between first and second substrates and laterally surrounding an electrochromic gel. The peripheral edge seal may protect the gel from water and oxygen. The peripheral edge seal may include one or more rings of material and/or a glass ring spacer, the substrates may include cavities, and/or the gel may include spacer beads to help minimize warpage upon curing and thus maximize flatness of the tint layer. The electrochromic gel may include first and second redox species and a third redox species configured to tune a color response of the tint layer.

This application claims the benefit of U.S. Provisional Patent Application No. 63/511,585, filed Jun. 30, 2023, which is hereby incorporated by reference herein in its entirety.

### BACKGROUND

This disclosure relates to optical systems such as optical systems in electronic devices having displays.

Electronic devices can include displays that provide images near the eyes of a user. Such electronic devices often include virtual or augmented reality headsets with displays having optical elements that allow users to view the displays.

If care is not taken, images presented by the displays can be washed out by bright ambient light. It can also be difficult to provide the displays with structures that meet desired levels of optical and mechanical performance.

### SUMMARY

An aspect of the disclosure provides an electronic device. The electronic device may include a waveguide configured to propagate first light, an optical coupler on the waveguide and configured to couple the first light out of the waveguide, and a tint layer overlapping the optical coupler and configured to pass second light to the waveguide. The tint layer may include a first substrate, a second substrate, an electrochromic gel between the first substrate and the second substrate, and a glass ring spacer between the first substrate and the second substrate, wherein the glass ring spacer extends around a lateral periphery of the electrochromic gel.

An aspect of the disclosure provides a display. The display may include a waveguide configured to propagate first light, an optical coupler on the waveguide and configured to couple the first light out of the waveguide, and an electrically adjustable tint layer overlapping the optical coupler and configured to pass second light to the waveguide. The electrically adjustable tint layer may include a first substrate, a second substrate, an electrochromic gel between the first substrate and the second substrate, a first edge seal between the first substrate and the second substrate and surrounding a lateral periphery of the electrochromic gel, and a second edge seal between the first and the second substrate and surrounding the lateral periphery of the electrochromic gel, the second edge seal being interposed between the first edge seal and the electrochromic gel.

An aspect of the disclosure provides an electronic device. The electronic device may include a waveguide configured to propagate first light, an optical coupler on the waveguide and configured to couple the first light out of the waveguide, and an electrically adjustable tint layer overlapping the optical coupler and configured to pass second light to the waveguide. The electrically adjustable tint layer can include a first substrate, a second substrate, an electrochromic gel between the first substrate and the second substrate, and an edge seal between the first substrate and the second substrate and surrounding a lateral periphery of the electrochromic gel, wherein the edge seal has a non-uniform width along the lateral periphery of the electrochromic gel.

An aspect of the disclosure provides an electronic device. The electronic device may include a waveguide configured to propagate first light, an optical coupler on the waveguide and configured to couple the first light out of the waveguide, and an electrically adjustable tint layer overlapping the optical coupler and configured to pass second light to the waveguide. The electrically adjustable tint layer can include a first substrate having a first lateral surface, a second substrate having a second lateral surface facing the first lateral surface, a ring of adhesive that couples the first lateral surface to the second lateral surface, a cavity in the first lateral surface, and an electrochromic gel between the first substrate and the second substrate and at least partially disposed within the cavity.

An aspect of the disclosure provides a display. The display can include a waveguide configured to propagate first light, an optical coupler on the waveguide and configured to couple the first light out of the waveguide, and an electrically adjustable tint layer overlapping the optical coupler and configured to pass second light to the waveguide. The electrically adjustable tint layer can include a first substrate having a first lateral surface, a first electrode on the first lateral surface, a second substrate having a second lateral surface facing the first lateral surface, a second electrode on the second lateral surface, an electrochromic gel between the first electrode and the second electrode, the electrochromic gel comprising a first redox species with a first optical absorptivity, a second redox species with a second optical absorptivity greater than the first optical absorptivity, and a third redox species with a third optical absorptivity less than the first optical absorptivity and less than the second optical absorptivity, the third redox species being configured to perform a same type of redox reaction as the second redox species, and a peripheral edge seal that couples the first lateral surface to the second lateral surface and that extends around a lateral periphery of the electrochromic gel.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with a tint layer for providing a virtual object overlaid with a real-world object to an eye box in accordance with some embodiments.

FIG. 3 is a top view of an illustrative tint layer having an electrochromic gel surrounded by a peripheral edge seal in accordance with some embodiments.

FIG. 4 is a cross-sectional top view of an illustrative tint layer having a peripheral edge seal formed from a single material in accordance with some embodiments.

FIG. 5 is a cross-sectional top view of an illustrative tint layer having concentric peripheral edge seals formed from multiple materials in accordance with some embodiments.

FIG. 6 is a cross-sectional top view of an illustrative tint layer having a peripheral edge seal with a glass ring spacer in accordance with some embodiments.

FIG. 7 is a cross-sectional top view of an illustrative tint layer having a substrate with a cavity in accordance with some embodiments.

FIG. 8 is a cross-sectional top view of an illustrative tint layer having spacer beads in accordance with some embodiments.

FIG. 9 is a cross-sectional top view of an illustrative tint layer having an electrochromic gel with three redox species for tuning the color response of the tint layer in accordance with some embodiments.

### DETAILED DESCRIPTION

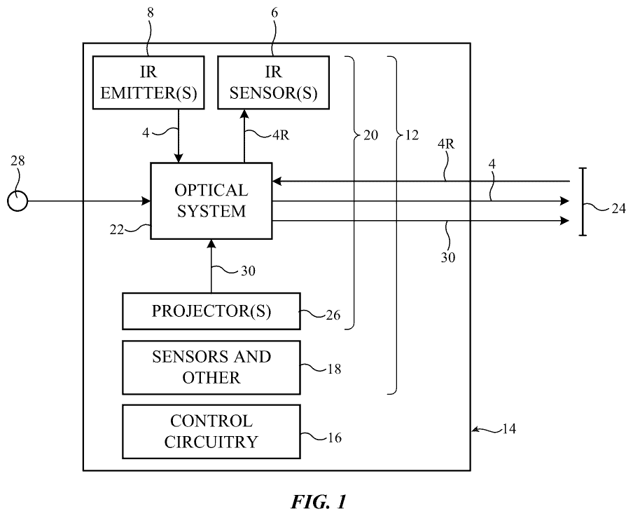

System 10 of FIG. 1 may be an electronic device such as a head-mounted device having one or more displays. The displays in system 10 may include near-eye displays 20 mounted within support structure such as housing 14. Housing 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as housing 14. Each projector 26 may emit image light 30 that is redirected towards a user's eyes at eye box 24 using an associated one of optical systems 22. Image light 30 may be, for example, visible light (e.g., including wavelengths from 400-700 nm) that contains and/or represents something viewable such as a scene or object (e.g., as modulated onto the image light using the image data provided by the control circuitry to the display module).

The operation of system 10 may be controlled using control circuitry 16. Control circuitry 16 may include storage and processing circuitry for controlling the operation of system 10. Control circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 16 and run on processing circuitry in control circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a viewer's eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner formed from reflective components, diffractive components, a waveguide, a direct view optical combiner, etc.) to allow real-world light (sometimes referred to as world light) from real-world (external) objects such as real-world (external) object 28 to be combined optically with virtual (computer-generated) images such as virtual images in image light 30. In this type of system, which is sometimes referred to as an augmented reality system, a user of system 10 may view both real-world content (e.g., world light from object 28) and computer-generated content that is overlaid on top of the real-world content. Camera-based augmented reality systems may also be used in device 10 (e.g., in an arrangement in which a camera captures real-world images of object 28 and this content is digitally merged with virtual content at optical system 22).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

If desired, system 10 may include an optical sensor. The optical sensor may be used to gather optical sensor data associated with a user's eyes at eye box 24. The optical sensor may, for example, be a gaze tracking sensor that gathers optical sensor data such as gaze image data (gaze tracking image data or gaze tracking sensor data) from a user's eye at eye box 24. Control circuitry 16 may process the optical sensor data to identify and track the direction of the user's gaze in real time. Control circuitry 16 may perform any desired operations based on the tracked direction of the user's gaze over time.

As shown in FIG. 1, the optical sensor (gaze tracking sensor) may include one or more optical emitters such as infrared emitter(s) 8 and one or more optical receivers (sensors) such as infrared sensor(s) 6 (sometimes referred to herein as optical sensor 6). Infrared emitter(s) 8 may include one or more light sources that emit sensing light such as light 4. Light 4 may be used for performing optical sensing on/at eye box 24 (e.g., gaze tracking) rather than conveying pixels of image data such as in image light 30. Light 4 may include infrared light. The infrared light may be at infrared (IR) wavelengths and/or near-infrared (NIR) wavelengths (e.g., any desired wavelengths from around 700 nm to around 15 microns). Light 4 may additionally or alternatively include wavelengths less than 700 nm if desired. Light 4 may sometimes be referred to herein as sensor light 4.

Infrared emitter(s) 8 may direct light 4 towards optical system 22. Optical system 22 may direct the light 4 emitted by infrared emitter(s) 8 towards eye box 24. Light 4 may reflect off portions (regions) of the user's eye at eye box 24 as reflected light 4R (sometimes referred to herein as reflected sensor light 4R, which is a reflected version of light 4). Optical system 22 may receive reflected light 4R and may direct reflected light 4R towards infrared sensor(s) 6. Infrared sensor(s) 6 may receive reflected light 4R from optical system 22 and may gather (e.g., generate, measure, sense, produce, etc.) optical sensor data in response to the received reflected light 4R. Infrared sensor(s) 6 may include an image sensor or camera (e.g., an infrared image sensor or camera), for example. Infrared sensor(s) 6 may include, for example, one or more image sensor pixels (e.g., arrays of image sensor pixels). The optical sensor data may include image sensor data (e.g., image data, infrared image data, one or more images, etc.). Infrared sensor(s) 6 may pass the optical sensor data to control circuitry 16 for further processing. Infrared sensor(s) 6 and infrared emitter(s) 8 may be omitted if desired.

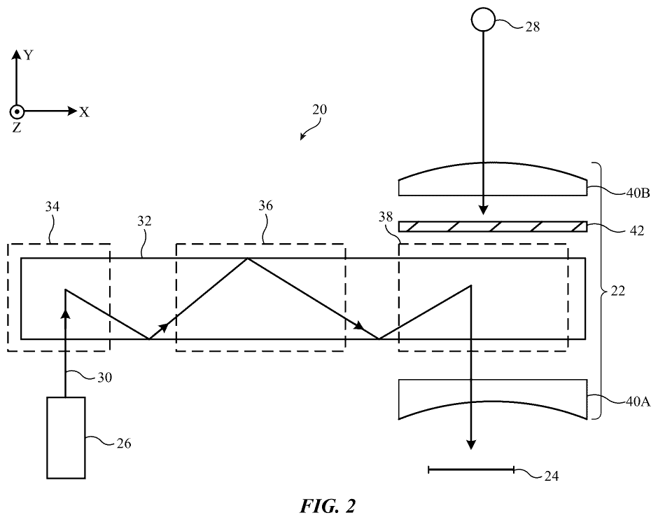

FIG. 2 is a top view of an illustrative display 20 that may be used in system 10 of FIG. 1. As shown in FIG. 2, display 20 may include a projector such as projector 26 and an optical system such as optical system 22. Optical system 22 may include optical elements such as one or more waveguides 32. Waveguide 32 may include one or more stacked substrates (e.g., stacked planar and/or curved layers sometimes referred to herein as waveguide substrates) of optically transparent material such as plastic, polymer, glass, etc.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating medium may include photopolymers, gelatin such as dichromated gelatin, silver halides, holographic polymer dispersed liquid crystal, or other suitable holographic media.

Diffractive gratings on waveguide 32 may include holographic phase gratings such as volume holograms or thin-film holograms, meta-gratings, or any other desired diffractive grating structures. The diffractive gratings on waveguide 32 may also include surface relief gratings (SRGs) formed on one or more surfaces of the substrates in waveguide 32 (e.g., as modulations in thickness of a SRG medium layer). The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired.

As shown in FIG. 2, projector 26 may generate (e.g., produce and emit) image light 30 associated with image content to be displayed to eye box 24 (e.g., image light 30 may convey a series of image frames for display at eye box 24). Image light 30 may be collimated using a collimating lens in projector 26 if desired. Optical system 22 may be used to present image light 30 output from projector 26 to eye box 24. If desired, projector 26 may be mounted within support structure 14 of FIG. 1 while optical system 22 may be mounted between portions of support structure 14 (e.g., to form a lens that aligns with eye box 24). Other mounting arrangements may be used, if desired.

Optical system 22 may include one or more optical couplers (e.g., light redirecting elements) such as input coupler 34, cross-coupler 36, and output coupler 38. In the example of FIG. 2, input coupler 34, cross-coupler 36, and output coupler 38 are formed at or on waveguide 32. Input coupler 34, cross-coupler 36, and/or output coupler 38 may be completely embedded within the substrate layers of waveguide 32, may be partially embedded within the substrate layers of waveguide 32, may be mounted to waveguide 32 (e.g., mounted to an exterior surface of waveguide 32), etc.

Waveguide 32 may guide image light 30 down its length via total internal reflection. Input coupler 34 may be configured to couple image light 30 from projector 26 into waveguide 32 (e.g., within a total-internal reflection (TIR) range of the waveguide within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., at angles outside of the TIR range). Input coupler 34 may include an input coupling prism, an edge or face of waveguide 32, a lens, a steering mirror or liquid crystal steering element, diffractive grating structures (e.g., volume holograms, SRGs, etc.), partially reflective structures (e.g., louvered mirrors), or any other desired input coupling elements.

As an example, projector 26 may emit image light 30 in direction +Y towards optical system 22. When image light 30 strikes input coupler 34, input coupler 34 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis). In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). In redirecting image light 30, cross-coupler 36 may also perform pupil expansion on image light 30 in one or more directions. In expanding pupils of the image light, cross-coupler 36 may, for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32.

Input coupler 34, cross-coupler 36, and/or output coupler 38 may be based on reflective and refractive optics or may be based on diffractive (e.g., holographic) optics. In arrangements where couplers 34, 36, and 38 are formed from reflective and refractive optics, couplers 34, 36, and 38 may include one or more reflectors (e.g., an array of micromirrors, partial mirrors, louvered mirrors, or other reflectors). In arrangements where couplers 34, 36, and 38 are based on diffractive optics, couplers 34, 36, and 38 may include diffractive gratings (e.g., volume holograms, surface relief gratings, etc.).

The example of FIG. 2 is merely illustrative. Optical system 22 may include multiple waveguides that are laterally and/or vertically stacked with respect to each other. Each waveguide may include one, two, all, or none of couplers 34, 36, and 38. Waveguide 32 may be at least partially curved or bent if desired. One or more of couplers 34, 36, and 38 may be omitted. If desired, optical system 22 may include a single optical coupler that performs the operations of both cross-coupler 36 and output coupler 38 (sometimes referred to herein as an interleaved coupler, a diamond coupler, or a diamond expander) or cross-coupler 36 may be separate from output coupler 38.

The operation of optical system 22 on image light 30 is shown in FIG. 2. Optical system 22 may also direct light 4 from infrared emitter(s) 8 towards eye box 24 and may direct reflected light 4R from eye box 24 towards infrared sensor(s) 6 (FIG. 1). In addition, output coupler 38 may form an optical combiner for image light 30 and world light from real-world objects such as real-world object 28. As shown in FIG. 2, world light from real-world object 28 may pass through output coupler 38, which transmits the world light (e.g., without diffracting the world light) to eye box 24.

Image light 30 may include images of virtual objects, sometimes referred to herein as virtual object images or simply as virtual objects. Projector 26 may receive image data that includes the virtual object images (e.g., pixels of image data at different pixel locations that form the virtual object images). Output coupler 38 may serve to overlay the virtual object images with world light from real-world object 28 within the field of view (FOV) of eye box 24. The control circuitry for system 10 may provide image data to projector 26 that places the virtual object images at desired locations within the FOV at eye box 24 (e.g., such that the virtual object images are overlaid with desired real-world objects in the scene/environment in front of system 10.)

Optical system 22 may include one or more lenses 40 that overlap output coupler 38. For example, optical system 22 may include at least a first lens 40A and a second lens 40B. Lens 40B may be interposed between waveguide 32 and real-world object 28. Lens 40A may be interposed between waveguide 32 and eye box 24. Lenses 40 are transparent and allow world light from real-world object 28 to pass to eye box 24 for viewing by the user. At the same time, the user can view virtual object images directed out of waveguide 32 and through lens 40A to eye box 24. Lenses 40A and 40B may sometimes also be referred to herein as lens elements.

The strength (sometimes referred to as the optical power, power, or diopter) of lens 40A can be selected to place virtual object images in image light 30 at a desired image distance (depth) from eye box 24 (sometimes referred to herein as a virtual object distance, virtual object image distance, virtual image distance (VID), virtual object depth, virtual image depth, or image depth). For example, it may be desirable to place virtual objects (virtual object images) such as text, icons, moving images, characters, effects, or other content or features at a certain virtual image distance (e.g., to integrate the virtual object image within, onto, into, or around the real-world objects in front of system 10). The placement of the virtual object at that distance can be accomplished by appropriate selection of the strength of lens 40A. Lens 40A may be a negative lens for users whose eyes do not have refraction errors. The strength (larger net negative power) of lens 40A can therefore be selected to adjust the distance (depth) of the virtual object. Lens 40A may therefore sometimes be referred to herein as bias lens 40A or bias− (B−) lens 40A.

If desired, lens 40B may have a complementary power value (e.g., a positive power with a magnitude that matches the magnitude of the negative power of lens 40A). Lens 40B may therefore sometimes be referred to herein as bias+ (B+) lens 40B, complementary lens 40B, or compensation lens 40B. For example, if lens 40A has a power of −2.0 diopter, lens 40B may have an equal and opposite power of +2.0 diopter (as an example). In this type of arrangement, the positive power of lens 40B cancels the negative power of lens 40A. As a result, the overall power of lenses 40A and 40B taken together will be 0 diopter. This allows a viewer to view real-world objects such as real-world object 28 without optical influence from lenses 40A and 40B. For example, a real-world object 28 located far away from system 10 (effectively at infinity), may be viewed as if lenses 40A and 40B were not present.

For a user with satisfactory uncorrected vision, this type of complementary lens arrangement therefore allows virtual objects to be placed in close proximity to the user (e.g., at a virtual image distance of 0.5-5 m, at least 0.1 m, at least 1 m, at least 2 m, less than 20 m, less than 10 m, less than 5 m, or other suitable near-to-midrange distance from device 10 while simultaneously allowing the user to view real world objects without modification by the optical components of the optical system). For example, a real-world object located at a distance of 2 m from device 10 (e.g., a real-world object being labeled by a virtual text label at a virtual image distance of 2 m) will optically appear to be located 2 m from device 10. This is merely illustrative and, if desired, lenses 40A and 40B need not be complementary lenses (e.g., lenses 40A and 40B may have any desired optical powers).

In addition, some users may require vision correction. Vision correction may be provided using tunable lenses, fixed (e.g., removable) lenses (sometimes referred to as supplemental lenses, vision correction lenses, removable lenses, or clip-on lenses), and/or by adjusting the optical power of lens 40A and/or lens 40B to implement the desired vision correction. In general, the vision correction imparted to the lens(es) may include corrections for ametropia (eyes with refractive errors) such as lenses to correct for nearsightedness (myopia), corrections for farsightedness (hyperopia), corrections for astigmatism, corrections for skewed vision, corrections to help accommodate age-related reductions in the range of accommodation exhibited by the eyes (sometimes referred to as presbyopia), and/or other vision disorders.

Lenses 40A and 40B may be provided with any desired optical powers and any desired shapes (e.g., may be plano-convex lenses, plano-concave lenses, plano-freeform lenses, freeform-convex lenses, freeform-concave lenses, convex-concave lenses, freeform-freeform lenses, etc.). Implementations in which the optical power(s) of lenses 40A and/or 40B are fixed (e.g., upon manufacture) are described herein as an example. If desired, one or both of lenses 40A and/or 40B may be electrically adjustable to impart different optical powers or power profiles over time (e.g., lenses 40A and/or 40B may be adjustable/tunable liquid crystal lenses).

In some operating conditions, such as when system 10 is operated outdoors, in rooms with bright lighting, or in other environments having relatively high light levels, world light from real-world objects 28 can overpower or wash out virtual objects presented to eye box 24 in image light 30, thereby limiting the contrast and visibility of the virtual objects when viewed at eye box 24. To reduce the brightness of the world light and maximize the contrast of the images (virtual objects) in image light 30 when viewed at eye box 24, optical system 22 may include a light-absorbing layer such as tint layer 42. Tint layer 42 may be disposed within the optical path between real-world objects 28 and output coupler 38. The world light from real-world objects 28 may pass through tint layer 42 prior to reaching eye box 24 (e.g., tint layer 42 may transmit the world light without transmitting image light 30). Tint layer 42 may absorb some of the real-world light, thereby reducing its brightness and increasing the contrast of virtual objects in image light 30 at eye box 24. If desired, the tint layer may also function to absorb real-world light, even when the virtual image is turned off, performing a function like switchable sunglasses.

Tint layer 42 may be a fixed tint layer or may be a dynamically adjustable tint layer. When implemented as a fixed tint layer, tint layer 42 has a fixed transmission profile that absorbs the same amount of incident world light over time. Fixed tint layers may be formed from a polymer film containing dye and/or pigment (as an example). When implemented as a dynamically (electrically) adjustable tint layer, tint layer 42 has a dynamically (electrically) adjustable transmission profile. In these implementations, tint layer 42 may be controlled by control signals from control circuitry 16. Implementations in which tint layer 42 is a dynamically adjustable tint layer are described herein as an example. However, in general, tint layer 42 as described herein may be replaced with a fixed tint layer.

Electrically adjustable tint layers (sometimes referred to as electrically adjustable light modulators or electrically adjustable light modulator layers) may be formed from an organic or inorganic electrochromic light modulator layer or a guest-host liquid crystal light modulator layer. When implemented using organic electrochromic tint materials, the active tint materials in the tint layer may be formed from one or more polymer layers which change their absorption upon being oxidized or reduced by charge from adjacent electrodes, or the active tint materials in the tint layer may be made from one or more species of organic small molecules, which diffuse in a liquid or gel medium and change their absorption upon being oxidized or reduced by charge from adjacent electrodes. When implemented using inorganic electrochromic tint materials, the active tint materials may be formed from one or more metal oxides, which change their absorption upon being oxidized or reduced by charge from adjacent electrodes, and may include counter-ions. Implementations in which tint layer 42 includes electrochromic tint material such as a layer of cured electrochromic gel are described herein as an example.

During operation of system 10, the electrically adjustable tint layer may be dynamically placed in a high transmission mode (sometimes referred to herein as a clear state) when it is desired to enhance the visibility of real-world objects or in a lower transmission mode (sometimes referred to herein as a dark state) when it is desired to reduce scene brightness and thereby help enhance the viewability of image light from projector 26 (e.g., to allow virtual objects such as virtual objects in image light 30 to be viewed without being overwhelmed by bright environmental light). If desired, tint layer 42 may also be controlled to exhibit intermediate levels of transmission and/or transmission levels that vary across the field of view of eye box 24.

Tint layer 42 may be planar (e.g., having a lateral surface that lies in a flat plane) or may be curved (e.g., having a lateral surface that is curved and non-planar). Tint layer 42 may be disposed at any desired location within optical system 22 between real-world objects 28 (e.g., the scene in front of system 10) and output coupler 38 on waveguide 32. Device 10 may include multiple overlapping tint layers if desired.

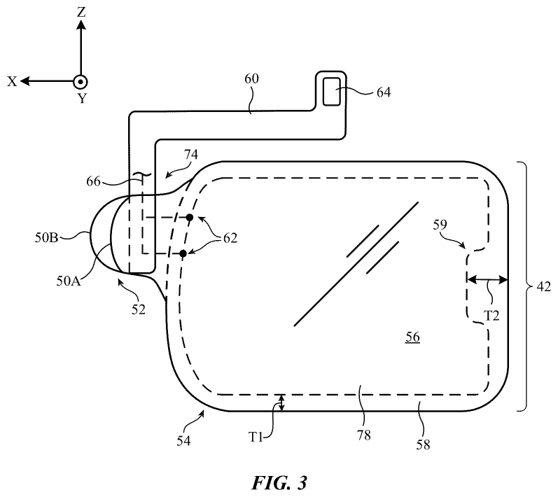

FIG. 3 is a front view of tint layer 42. In the example of FIG. 3, waveguide 32, projector 26, and lenses 40 of FIG. 2 have been omitted for the sake of clarity. As shown in FIG. 3, tint layer 42 may include one or more substrates layers 50 such as a first substrate 50A and a second substrate 50B. Substrates 50A and 50B may include glass (e.g., substrates 50A and 50B may be glass layers), polymer (e.g., plastic), or other transparent materials. Substrate layers 50 may sometimes also be referred to herein simply as substrates 50. Substrates 50A and 50B may sometimes also be referred to herein as substrate layers 50A and 50B or simply as layers 50A and 50B.

Substrate 50B may overlap substrate 50A and may be mounted to substrate 50A. When mounted together, substrates 50A and 50B may define a cavity between substrate 50A and substrate 50B. The cavity may be filled with a layer of electrochromic tint material such as electrochromic gel 78. Electrochromic gel 78 may form the active area 56 of tint layer 42. Tint layer 42 may transmit light to waveguide 32 through active area 56 of tint layer 42 (e.g., while absorbing some of the light, providing the transmitted light with a desired color response, etc.).

Electrochromic gel 78 may be cured and/or solidified during manufacture of tint layer 42. Electrochromic gel 78 may sometimes also be referred to herein as electrochromic layer 78, electrochromic tint material 78, electrochromic material 78, or tint material 78. A peripheral ring of adhesive such as peripheral edge seal 58 may be used to laterally contain electrochromic gel 78 within active area 56 while helping to space substrate 50A apart from substrate 50B. Peripheral edge seal 58 may also serve to mount or adhere substrates 50A and 50B together.

As shown in FIG. 3, substrates 50A and 50B may include an extension 52 that extends or protrudes away from electrochromic gel 78 and peripheral edge seal 58. Tint layer 42 may be driven by one or more conductive lines coupled to tint layer 42 at or through extension 52. For example, tint layer 42 may be driven by a printed circuit board such as flexible printed circuit 60. Flexible printed circuit 60 may include one or more control lines 66 (e.g., one or more conductive traces). Control lines 66 may be coupled to control circuitry 16 (FIG. 1) over connector 64 (e.g., a board-to-board connector). Control lines 66 may extend into one or more tails 74 of flexible printed circuit 60. Tail(s) 74 of flexible printed circuit 60 may be coupled to tint layer 42 (e.g., at extension 52). Tail(s) 74 of flexible printed circuit 60 may, if desired, be adhered or mounted to substrate 50A and/or substrate 50B.

Tint layer 42 may include first and second transparent conductive layers (not shown in FIG. 3 for the sake of clarity) extending along substrates 50A and 50B and the electrochromic gel 78 in active area 56. The transparent conductive layers may form electrodes for tint layer 42. The electrodes may extend along opposing sides of electrochromic gel 78. The electrodes may have terminals 62 that are coupled to control lines 66 on flexible printed circuit 60. Control lines 66 may sometimes also be referred to herein as drive lines 66.

Flexible printed circuit 60 may receive control signals such as different control voltages from control circuitry 16 (FIG. 1) for driving, controlling, setting, and/or adjusting the light transmission properties of tint layer 42. Flexible printed circuit 60 may pass the control signals to the electrodes of tint layer 42 over control lines 66 and terminals 62. By adjusting the voltage across terminals 62, the electric field applied by the electrodes of tint layer 42 across electrochromic gel 78 may be adjusted, thereby adjusting the amount of light transmission exhibited by electrochromic gel 78 and thus tint layer 42.

In an illustrative configuration, electrochromic gel 78 and tint layer 42 may exhibit a variable amount of light transmission ranging continuously between a minimum level of TMIN and a maximum level of TMAX. The value of TMIN may be 5%, 10%, 15%, 20%, 2-15%, 3-25%, 5-40%, 10-30%, 10-25%, at least 3%, at least 6%, at least 15%, at least 20%, less than 35%, less than 25%, less than 15%, or other suitable minimum level sufficient to help reduce environmental (real-world) light during viewing of computer-generated images from projectors 26 in bright environmental lighting conditions. The value of TMAX may be at least 50%, at least 60%, 60-99%, 40-99.9%, 80-99%, 70-99%, 80-97%, at least 70%, at least 80%, at least 85%, at least 90%, at least 95%, less than 99.99%, less than 99%, or other suitable maximum level sufficiently transparent to allow a viewer to comfortably view real world objects through tint layer 42 during situations where projectors 26 (FIG. 2) are not supplying images or other situations where higher transmission levels are desirable. If desired, the control voltage may also be adjusted to adjust a color response (e.g., transmission as a function of wavelength) of electrochromic gel 78.

If desired, anti-reflective coatings (not shown) may be disposed on one or both of substrates 50A and 50B. In implementations where tint layer 42 is curved, substrates 50A and 50B may be curved. The example of FIG. 3 in which tint layer 42 includes two substrates 50 is illustrative and non-limiting. If desired, tint layer 42 may include only a single substrate 50 or more than two substrates 50.

In general, it may be desirable for tint layer 42 to be as flat as possible (e.g., within the X-Z plane of FIG. 3). Maximizing flatness may allow tint layer 42 to be more easily mounted within device 10 (e.g., to a surface waveguide 32 of FIG. 2), may allow tint layer 42 to be more mechanically robust over the operating lifetime of device 10 (e.g., with minimal damage to tint layer 42 and/or to the coupling between tint layer 42 and waveguide 32 over time as device 10 is subjected to external forces, thermal stress, etc.), may minimize the production of reflections, ghost, rainbow artifacts, or other cosmetic artifacts by tint layer 42, etc.

If desired, peripheral edge seal 58 may have a single uniform thickness T1 (e.g., as measured in the X-Z plane) along its length around the periphery of electrochromic gel 78. In general, configuring thickness T1 to be as small as possible may serve to minimize the amount of warpage imparted to tint layer 42 upon curing of peripheral edge seal 58. However, if desired, peripheral edge seal 58 may have multiple different thicknesses around the periphery (e.g., circumference) of active area 56. For example, peripheral edge seal 58 may have one or more thicker portions (regions or segments) 59 having a thickness T2 that is greater than thickness T1 (e.g., peripheral edge seal 58 may have an asymmetric amount of material along its length or about the periphery of electrochromic gel 78). Thicker portions 59 (sometimes referred to as edge seal tabs 59 or edge seal reservoirs 59) may, for example, help to counteract epoxy shrinkage on different sides of tint layer 42 during the manufacture and curing process of tint layer 42 (e.g., to balance the stress profile of tint layer 42 across its lateral area in the X-Z plane), thereby ensuring that tint layer 42 is as flat as possible. In addition, thicker portions 59 may help to increase the mechanical integrity with which substrates 50A and 50B are adhered together, for example.

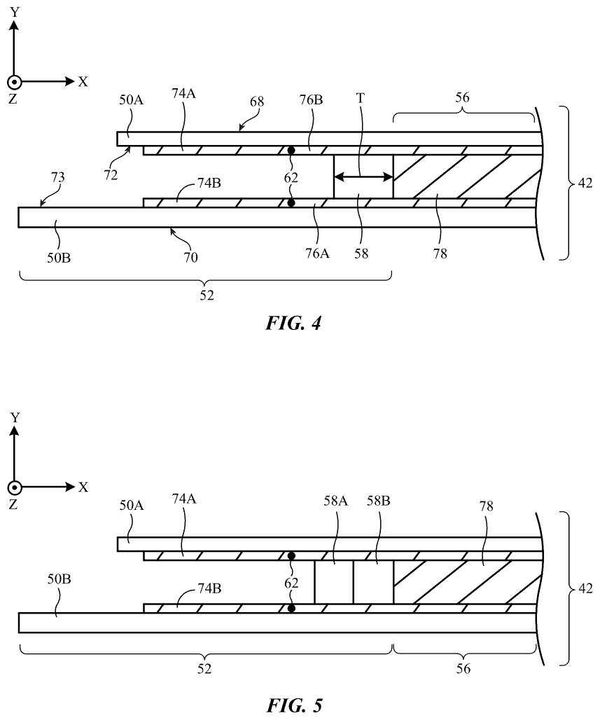

FIG. 4 is a cross-sectional top view of tint layer 42. As shown in FIG. 4, substrates 50A and 50B may extend along opposing sides of electrochromic gel 78 (e.g., electrochromic gel 78 may be sandwiched or interposed between substrates 50A and 50B). Substrate 50A may have a first lateral surface 68 and an opposing second lateral surface 72. Substrate 50B may have a first lateral surface 73 and an opposing second lateral surface 70. Lateral surface 70 or lateral surface 68 may be mounted to a lateral surface of waveguide 32 (FIG. 2) using optically clear adhesive, epoxy, spacers, or other mounting structures. Lateral surfaces 72 and 73 may face electrochromic gel 78.

Tint layer 42 may include a first electrode layer such as electrode 76B that is layered onto lateral surface 72 and that is interposed between substrate 50A and electrochromic gel 78. Tint layer 42 may also include a second electrode layer such as electrode 76A that is layered onto lateral surface 73 and that is interposed between substrate 50B and electrochromic gel 78. Flexible printed circuit 60 (FIG. 3) may include one or more tails 74 such as a first tail 74A mounted to lateral surface 72 of substrate 50A and a second tail 74B mounted to lateral surface 73 of substrate 50B. Control lines 66 (FIG. 3) on tails 74A and 74B may be coupled to electrodes 76A and 76B, respectively, at terminals 62. This is illustrative and, if desired, flexible printed circuit 60 may be replaced with conductive wires or any other desired conductors for conveying control signals to electrodes 76A and 76B.

Tails 74A and 74B may provide voltages across electrodes 76A and 76B (through terminals 62) that cause materials in electrochromic gel 78 to perform an oxidation-reduction (redox) reaction. The redox reaction may configure electrochromic gel 78 to exhibit a desired level of optical transmission and/or to exhibit a desired color profile. The voltage may be changed over time to change the level of optical transmission and/or the color profile over time.

As shown in FIG. 4, peripheral edge seal 58 may couple lateral surface 72 of substrate 50A to lateral surface 73 of substrate 50B. Peripheral edge seal 58 may extend around the lateral periphery of electrochromic gel 78 (e.g., as shown in FIG. 3) to confine (e.g., completely surround) electrochromic gel 78 within active area 76 and between substrates 50A and 50B. Peripheral edge seal 58 may help to prevent electrochromic gel 78 from leaking out of tint layer 42, may serve to protect electrochromic gel 78 from moisture or other contaminants, and may serve to prevent exposure of oxygen in the air around 42 to electrochromic gel 78, thereby allowing electrochromic gel 78 to continue to perform the expected redox reactions in response to voltages applied across the electrodes and without degrading or otherwise damaging the electrochromic gel, the redox reaction within the electrochromic gel, or the electrodes.

Peripheral edge seal 58 may have thickness T (e.g., thickness T1 or T2 of FIG. 3). If desired, thickness T may be relatively small (e.g., less than 1.0 mm, 0.2-0.7 mm, 0.5 mm, 0.1-1.0 mm, or other thicknesses) to minimize the amount of warpage of tint layer 42 caused by the curing of electrochromic gel 78. Thickness T may also sometimes be referred to herein as the width W of peripheral edge seal 58. In the example of FIG. 4, peripheral edge seal 58 is formed from a single ring of material that extends around the periphery of electrochromic gel 78. The material in peripheral edge seal 58 may exhibit relatively low cure shrinkage (e.g., to minimize stress on substrates 50A and 50B and to thereby allow tint layer 42 to remain as flat as possible after curing), may form a robust barrier to oxygen and/or water (e.g., to prevent contamination or damage to electrochromic gel 78), and/or may be chemically compatible with electrochromic gel 78 (e.g., does not chemically react with electrochromic gel 78). Peripheral edge seal 58 may be formed from epoxy or polyisobutylene, as two examples.

The example of FIG. 5 in which tint layer 42 includes a peripheral edge seal formed from a single ring of material is illustrative and non-limiting. If desired, tint layer 42 may include multiple peripheral edge seals formed from multiple nested rings of edge seal material, as shown in the example of FIG. 5. As shown in FIG. 5, tint layer 42 may include a first peripheral edge seal 58A and a second peripheral edge seal 58B nested within peripheral edge seal 58A. For example, peripheral edge seal 58A may be formed from a first ring of edge seal material and peripheral edge seal 58B may be formed from a second ring of edge seal material that is concentric within peripheral edge seal 58A. Put differently, peripheral edge seal 58B may be laterally interposed between peripheral edge seal 58A and electrochromic gel 78.

In these configurations, the material used to form peripheral edge seal 58B may be selected to exhibit maximal chemically compatibility with electrochromic gel 78 whereas the material used to form peripheral edge seal 58A may be selected to form a maximal barrier to oxygen (e.g., O2 gas) and/or water. Both peripheral edge seals 58A and 58B may exhibit relatively low cure shrinkage. In this way, the peripheral edge seals may be optimized to protect electrochromic gel 78 even if there is no single material that exhibits both adequate levels of chemical compatibility with electrochromic gel 78 and adequate levels of oxygen and water protection. As one example, peripheral edge seal 58A may be formed from polyisobutylene whereas peripheral edge seal 58B is formed from epoxy.

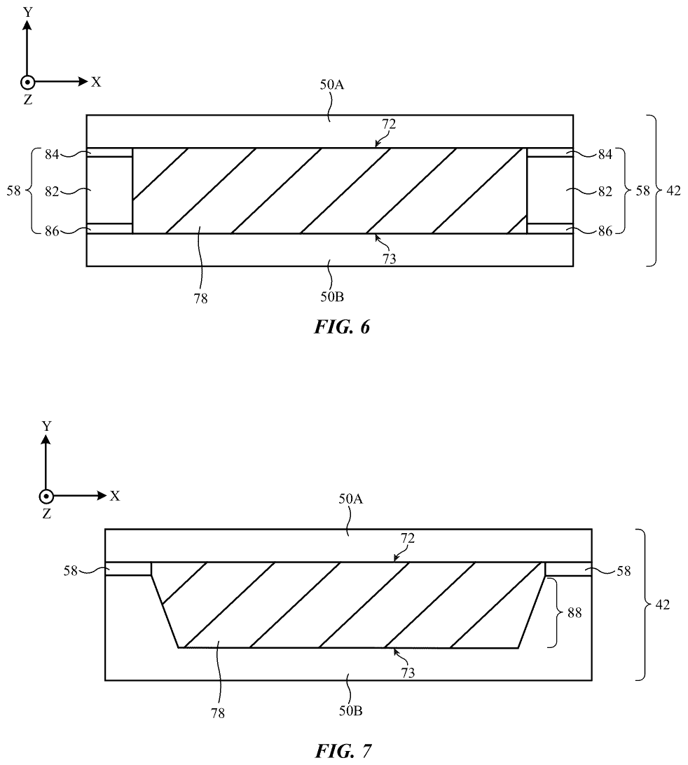

The example of FIG. 5 is illustrative and non-limiting. If desired, tint layer 42 may have three or more peripheral edge seals 58 (e.g., three or more concentric rings of peripheral edge seal material). If desired, tint layer 42 may include one or more anti-reflective coatings, index-matching layers, and/or any other desired additional layers (not shown). In some configurations, peripheral edge seal 58 may include a glass ring spacer. FIG. 6 is a top view showing one example of how peripheral edge seal 58 may include a glass ring spacer. In the example of FIG. 6, electrodes 76 and tails 74 of FIGS. 4 and 5 have been omitted for the sake of clarity.

As shown in FIG. 6, peripheral edge seal 58 may include a glass ring spacer such as glass ring spacer 82. Glass ring spacer 82 may be formed from a ring of glass that extends around the lateral periphery of electrochromic gel 78. Glass ring spacer 82 may be adhered to lateral surface 72 of substrate 50A using adhesive 84 (e.g., a ring of epoxy, optically clear adhesive, etc.). Glass ring spacer 82 may be adhered to lateral surface 73 of substrate 50B using adhesive 86 (e.g., a ring of epoxy, optically clear adhesive, etc.). Adhesive 84, adhesive 86, and glass ring spacer 82 may serve to confine electrochromic gel 78 between substrates 50A and 50B. Glass ring spacer 82 may serve to reduce the amount of adhesive (e.g., epoxy) used to secure substrates 50A and 50B together. This reduction in adhesive volume may serve to minimize the warpage of tint layer 42 upon curing of the adhesive, thereby maximizing the flatness of tint layer 42. Glass ring spacer 82 may be formed from other materials if desired (e.g., plastic, rubber, ceramic, sapphire, etc.).

Additionally or alternatively, substrate 50B may include a cavity for electrochromic gel 78. FIG. 7 is a top view showing one example of how substrate 50B may include a cavity for electrochromic gel 78. In the example of FIG. 7, electrodes 76 and tails 74 of FIGS. 4 and 5 have been omitted for the sake of clarity.

As shown in FIG. 7, substrate 50B may include a cavity 88 in lateral surface 73. For example, substrate 50B may exhibit a first thickness outside of cavity 88 and parallel to the Y-axis (e.g., 400 microns, 200-600 microns, 300-500 microns, more than 250 microns, etc.) and a second thickness within cavity 88 and parallel to the Y-axis that is less than the first thickness (e.g., 200 microns, 100-300 microns, 50-350 microns, less than 250 microns, etc.). Cavity 88 may also sometimes be referred to herein as recess 88, slot 88, or notch 88 in substrate 50B. Cavity 88 may have any desired shape.

Lateral surface 73 (e.g., outside of cavity 88) may be mounted to lateral surface 72 of substrate 50A using peripheral edge seal 58 (e.g., a ring of adhesive, epoxy, polyisobutylene, a glass ring spacer, etc.). Peripheral edge seal 58 may be relatively thin in this configuration (e.g., 10 microns, 1-20 microns, 10-50 microns, etc.). Electrochromic gel 78 may fill cavity 88. Cavity 88 may serve to minimize the amount of adhesive (e.g., epoxy) required to adhere substrates 50A and 50B together (e.g., by increasing the thickness of substrate 50B around the lateral periphery of electrochromic gel 78), thereby minimizing cure warpage and thus maximizing the flatness of tint layer 42.

The example of FIG. 7 is illustrative and non-limiting. Cavity 78 may alternatively be formed in substrate 50A. If desired, both lateral surface 72 of substrate 50A and lateral surface 73 of substrate 50B may include a cavity such as cavity 78. If desired, one or more spacer beads may be disposed between substrates 50A and 50B to help maximize the flatness of tint layer 42.

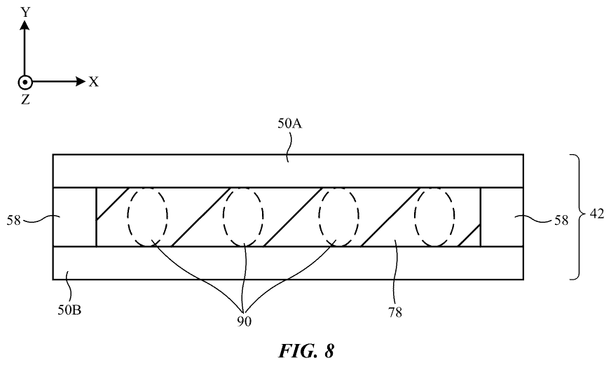

FIG. 8 is a top view showing one example of how one or more spacer beads may be disposed between substrates 50A and 50B to help maximize the flatness of tint layer 42. In the example of FIG. 8, electrodes 76 and tails 74 of FIGS. 4 and 5 have been omitted for the sake of clarity.

As shown in FIG. 8, one or more spacer beads 90 may be disposed in the space between substrates 50A and 50B and laterally surrounded by peripheral edge seal 58. Spacer beads 90 may be embedded within electrochromic gel 78. If desired, spacer beads 90 may be formed from the same material as electrochromic gel 78. In this configuration, spacer beads 90 may be deposited in an empty cavity between substrates 50A and 50B during assembly of tint layer 42. The remainder of the cavity may then be filled with electrochromic gel 78. Spacer beads 90 may serve to minimize warpage and thus maximize flatness during and after curing of the gel and/or peripheral edge seal 58. After curing, spacer beads 90 and electrochromic gel 78 become a single homogenous layer, thereby hiding spacer beads 90 from view by the user.

In other configurations, spacer beads 90 may be formed from a different material than electrochromic gel 78. In these configurations, spacer beads 90 may remain present between substrates 50A and 50B after curing. The material of spacer beads 90 may be selected to exhibit as close a refractive index as electrochromic gel 78 as possible to minimize the visibility of spacer beads 90 to the user. In general, the arrangements of FIGS. 4-8 may be combined in any desired manner.

If desired, various manufacturing techniques may be employed to maximize the flatness of tint layer 42 after curing of electrochromic gel 78 and peripheral edge seal(s) 58. For example, tint layer 42 may be overfilled with electrochromic material 78 at a relatively high temperature prior to curing. This may cause substrates 50A and 50B to bend outwards away from electrochromic gel 78 prior to curing. The electrochromic gel may then be cured and cooled, which may cause electrochromic gel 78 to shrink, reversing the bending of substrates 50A and 50B and leaving the substrates with a flat (planar) shape at room temperature after curing. As another example, during manufacture, electrochromic gel 78 may first be deposited as a freestanding layer onto substrate 50B (e.g., using a screen print process, an inkjet process, a slot die process, etc.). Peripheral edge seal 58 may then be deposited as a high viscosity free-standing material onto substrate 50B and laterally surrounding electrochromic gel 78. Substrate 50A may then be placed on top of the electrochromic gel and the peripheral edge seal and the peripheral edge seal may then be cured to form a flat tint layer 42.

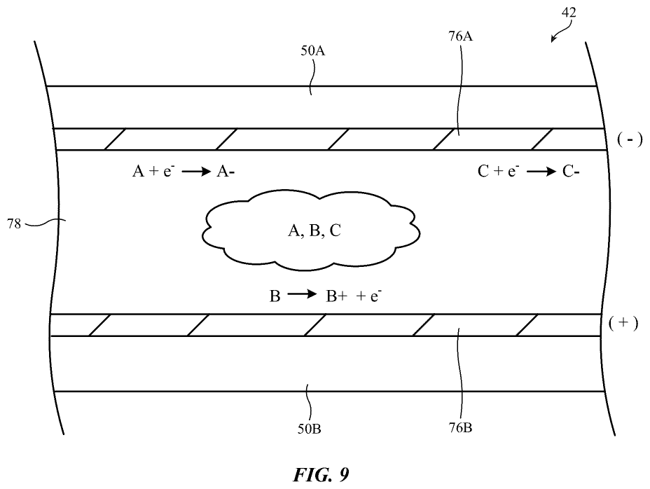

In general, electrochromic gel 78 may be formed from any desired electrochromic material. The electrochromic material may include at least a first redox active species A and a second redox active species B. If desired, a third redox species C may be added to the electrochromic material to tune the color response of the tint layer. FIG. 9 is a cross-sectional top view of tint layer 42 showing how electrochromic gel 78 may include a third redox species C that serves to tune the color response of the tint layer.

As shown in FIG. 9, electrochromic gel 78 may include species A, B, and C between a negative (−) electrode 76A on substrate 50A and a positive (+) electrode 76B on substrate 50B. First consider an example in which electrochromic gel 78 only includes species A and B. When a voltage is applied across electrodes 76A and 76B (e.g., using flexible printed circuit 60 of FIG. 3), species A is reduced (gains an electron) at electrode 76A to form the negatively charged species A− at electrode 76A. At the same time, species B is oxidized (loses an electron) at electrode 76B to form the positively charged species B+ at electrode 76B (e.g., the electrons lost by species B at electrode 76B reduce species A at electrode 76A).

In configurations where electrochromic gel 78 only includes two redox active species, A and B, the color response of tint layer 42 in the dark state (e.g., a state of minimal light transmission) is dictated by the relative molar absorptivities, the diffusion coefficients, and the total concentrations of species A and B. If the redox states of A and B in the dark state of tint layer 42 have very different molar absorptivities, then the dark state color of tint layer 42 will be dominated by the species with higher optical absorptivity. This can lead to an undesirable (e.g., non-neutral) color response in the dark state.

Such an undesirable color response cannot be resolved by simply reducing the concentration of the more-absorbing species. This is because every electron used to generate one of the species in the redox reaction must be used to generate the opposing species in a 1:1 ratio. To mitigate these issues and to produce a more neutral color response in the dark state, electrochromic gel 78 may further include a third redox species C. Species C may undergo the same type of redox reaction (oxidation or reduction) as whichever of species A or B absorbs more light at similar electric potentials (e.g., species C may undergo reduction if species A is more absorbing than species B or may undergo oxidization if species B is more absorbing than species A).

In the example of FIG. 9, species A absorbs more light in the dark state than species B so species C may be selected as a species that undergoes reduction. Unlike species A and B, species C may be a colorless species or a species that is less strongly colored in both the transparent and dark states of tint layer 42 than species A and species B. When a voltage is applied across electrodes 76A and 76B (e.g., using flexible printed circuit 60 of FIG. 3), species A is reduced at electrode 76A to form the negatively charged species A− at electrode 76A. At the same time, species C is reduced (gains an electron) at electrode 76A to form the negatively charged species C− at electrode 76A. Concurrently, species B is oxidized at electrode 76B to form the positively charged species B+ at electrode 76B (e.g., the electrons lost by species B at electrode 76B reduce both species A and species C at electrode 76A). In other words, species C may be used to gain some of the electrons lost by species B upon oxidation, which serves to reduce the amount of species A that is reduced and thus the overall contribution to the total color response of tint layer 42 caused by the reduction of species A. In this way, species C may be used to tweak the amount of color response caused by species A and may thus be used to tune or tweak the overall color response of tint layer 42 without requiring any significant changes in the chemistry of electrochromic gel 78. As one example, species A may include a viologen or viologen derivative (e.g., viologen molecules having the chemical formula C₅H₄NR₂ⁿ⁺), species B may include phenazine or a phenazine derivative (e.g., phenazine molecules having the chemical formula (C₆H₄)₂N₂), and species C may include salts of ferrocyanide and ferricyanide (e.g., [Fe(CN)₆³⁺, Fe(CN)₆⁴⁺]), ferrocene, vanadium salts, quinone/hydroquinone, napthaquinone, anthraquinone, 1-methy-1H-tetrazole-5-thiolate, or other redox active non-absorbing molecules.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. An electronic device comprising:
a waveguide configured to propagate first light;
an optical coupler on the waveguide and configured to couple the first light out of the waveguide; and
a tint layer overlapping the optical coupler and configured to pass second light to the waveguide, wherein the tint layer comprises
a first substrate,
a second substrate,
an electrochromic gel between the first substrate and the second substrate, and
a glass ring spacer between the first substrate and the second substrate, wherein the glass ring spacer extends around a lateral periphery of the electrochromic gel.

2. The electronic device of claim 1, wherein the tint layer comprises:
a first electrode on the first substrate; and
a second electrode on the second substrate, wherein the electrochromic gel is configured to undergo a redox reaction in response to a voltage applied across the first and second electrodes.

3. The electronic device of claim 1, wherein the electrochromic gel comprises:
a first species that reduces in response to the voltage applied across the first and second electrodes;
a second species that oxidizes in response to the voltage applied across the first and second electrodes, wherein the second species is more absorptive than the first species; and
a third species that oxides or reduces in response to the voltage applied across the first and second electrodes, the third species being less absorptive than the first species and the second species.

4. The electronic device of claim 1, wherein the electrochromic gel comprises:
a first species that reduces in response to the voltage applied across the first and second electrodes;
a second species that oxidizes in response to the voltage applied across the first and second electrodes, wherein the first species is more absorptive than the second species; and
a third species that reduces or oxidizes in response to the voltage applied across the first and second electrodes, the third species being less absorptive than the first species and the second species.

5. The electronic device of claim 1, wherein the tint layer further comprises:
a first layer of adhesive that adheres the glass ring spacer to the first substrate; and
a second layer of adhesive that adheres the glass ring spacer to the second substrate.

6. The electronic device of claim 1, wherein the first substrate and the second substrate comprise glass.

7. The electronic device of claim 1, wherein the optical coupler is configured to couple the first light out of the waveguide through a first surface of the waveguide, the tint layer being configured to pass the second light into the waveguide through a second surface of the waveguide opposite the first surface.

8. The electronic device of claim 7, wherein the tint layer is mounted to the waveguide.

9. The electronic device of claim 1, the tint layer further comprising:
spacer beads embedded in the electrochromic gel between the first substrate and the second substrate.

10. The electronic device of claim 1, further comprising:
a cavity in the first substrate, wherein at least some of the electrochromic gel is disposed in the cavity.

11. A display comprising:
a waveguide configured to propagate first light;
an optical coupler on the waveguide and configured to couple the first light out of the waveguide; and
an electrically adjustable tint layer overlapping the optical coupler and configured to pass second light to the waveguide, wherein the electrically adjustable tint layer comprises
a first substrate,
a second substrate,
an electrochromic gel between the first substrate and the second substrate,
a first edge seal between the first substrate and the second substrate and surrounding a lateral periphery of the electrochromic gel, and
a second edge seal between the first and the second substrate and surrounding the lateral periphery of the electrochromic gel, the second edge seal being interposed between the first edge seal and the electrochromic gel.

12. The display of claim 11, wherein the first edge seal comprises a first ring of material and the second edge seal comprises a second ring of material concentric with the first ring of material.

13. The display of claim 11, wherein the first edge seal comprises polyisobutylene.

14. The display of claim 13, wherein the second edge seal comprises epoxy.

15. The display of claim 14, wherein the first substrate and the second substrate comprise glass.

16. An electronic device comprising:
a waveguide configured to propagate first light;
an optical coupler on the waveguide and configured to couple the first light out of the waveguide; and
an electrically adjustable tint layer overlapping the optical coupler and configured to pass second light to the waveguide, wherein the electrically adjustable tint layer comprises
a first substrate,
a second substrate,
an electrochromic gel between the first substrate and the second substrate, and
an edge seal between the first substrate and the second substrate and surrounding a lateral periphery of the electrochromic gel, wherein the edge seal has a non-uniform width along the lateral periphery of the electrochromic gel.

17. An electronic device comprising:
a waveguide configured to propagate first light;
an optical coupler on the waveguide and configured to couple the first light out of the waveguide; and
an electrically adjustable tint layer overlapping the optical coupler and configured to pass second light to the waveguide, wherein the electrically adjustable tint layer comprises
a first substrate having a first lateral surface,
a second substrate having a second lateral surface facing the first lateral surface,
a ring of adhesive that couples the first lateral surface to the second lateral surface,
a cavity in the first lateral surface, and
an electrochromic gel between the first substrate and the second substrate and at least partially disposed within the cavity.

18. A display comprising:
a waveguide configured to propagate first light;
an optical coupler on the waveguide and configured to couple the first light out of the waveguide; and
an electrically adjustable tint layer overlapping the optical coupler and configured to pass second light to the waveguide, wherein the electrically adjustable tint layer comprises
a first substrate having a first lateral surface,
a first electrode on the first lateral surface,
a second substrate having a second lateral surface facing the first lateral surface,
a second electrode on the second lateral surface,
an electrochromic gel between the first electrode and the second electrode, the electrochromic gel comprising a first redox species with a first optical absorptivity, a second redox species with a second optical absorptivity greater than the first optical absorptivity, and a third redox species with a third optical absorptivity less than the first optical absorptivity and less than the second optical absorptivity, the third redox species being configured to perform a same type of redox reaction as the second redox species, and
a peripheral edge seal that couples the first lateral surface to the second lateral surface and that extends around a lateral periphery of the electrochromic gel.

19. The display of claim 18, wherein the first redox species comprises a viologen and the second redox species comprises a phenazine.

20. The display of claim 18, wherein the second redox species comprises a viologen and the first redox species comprises a phenazine.
